(19) United States
(12) Patent Application Publication
(10) Pub. No.: US 2011/0302369 A1
(43) Pub. Date: Dec. 8, 2011

(54) STORAGE APPARATUS AND CONTROL METHOD THEREFOR

(75) Inventors: Satoru GOTO, Nagoya-shi (JP); Yukihito HARA, Nagoya-shi (JP)

(73) Assignee: Buffalo Inc., Nagoya-shi (JP)

(21) Appl. No.: 13/151,760

(22) Filed: Jun. 2, 2011

(30) Foreign Application Priority Data
Jun. 3, 2010 (JP) 2010-128327

(51) Int. Cl. G06F 12/16

(52) U.S. Cl. 711/114; 711/E12.103

(57) ABSTRACT

A storage apparatus includes a storage unit including plural storage media, and a controller for controlling the storage unit. After a new storage medium has been added to the storage unit, the controller causes the new storage medium to store error correction codes for data stored in the respective storage media pre-existing in the storage unit. When new data is stored in the storage unit after the addition of the new storage medium, the controller causes the pre-existing storage media and the new storage medium to dispersedly store the new data and error correction codes for the new data.

### CROSS REFERENCE TO RELATED APPLICATION

This application is based upon and claims the benefit of priority from the prior Japanese Patent Application No. 2010-128327 filed on Jun. 3, 2010; the entire contents of which are incorporated herein by reference.

### BACKGROUND OF THE INVENTION

1. Field of the Invention

This invention relates to a storage apparatus to which the idea of a RAID system is applied and to a control method for the storage apparatus.

2. Description of the Related Art

Redundant arrays of inexpensive disks (RAID) are a widely used technology capable of building a highly reliable storage apparatus by the use of plural storage media such as hard disk drives (HDDs). In the RAID technology, plural storage media in combination work as a single logical storage unit (i.e. disk array).

Redundancy and data arrangement in RAID (hereinafter referred to as “RAID mode”) are determined mainly depending on the number of the storage media. RAID 1 uses two or more media, RAID 3, 4, or 5 use three or more media, and RAID 6 uses four or more media.

In RAID 1, the same data is stored in plural storage media. In RAID 3 or 4, error correction codes are stored exclusively in one of the storage media (hereinafter, referred to as an error-correction-dedicated storage medium), and data is dispersedly stored in the rest of the storage media. In RAID 5 or 6, no error-correction-dedicated storage medium is provided and data and error correction codes are dispersedly stored in plural storage media. The RAID modes, which are well-known to the public, are not described here in detail.

Generally, to change the RAID modes, the data stored in the storage media forming the disk array needs to be once saved in other places, and then is rewritten to the storage media. For a terabyte storage apparatus, such an operation requires tremendous amounts of time and work for copying and moving data and for checking the data integrity.

To avoid this difficulty, a technique has been proposed that allows the addition of a new storage medium to a RAID 3 or 4 disk array while maintaining the contents in the storage media pre-existing in the disk array (see, for example, Patent Literature 1: Japanese Patent Application Publication No. 2006-244513). In this technique, initial data to be stored in the new storage medium is set to a value which does not affect the error correction code, i.e. zero, whereby the recalculation of the error correction code can be omitted.

### SUMMARY OF THE INVENTION

The technique in Patent Literature 1 can increase the number of storage media that form the RAID 3 or 4 disk array while maintaining the contents stored in the pre-existing storage media, but has the following problems.

Firstly, with the technique disclosed in Patent Literature 1, the RAID mode stays in RAID 3 or 4 even after the new storage medium has been added and cannot be changed to another RAID mode.

Secondly, the technique disclosed in Patent Literature 1 requires the provision of an error-correction-dedicated storage medium, and thus cannot be applied to RAID modes other than RAID 3 and 4.

In RAID 3 or 4, the error-correction-dedicated storage medium needs to be accessed for every data update, and this access to the error-correction-dedicated storage medium may be a bottleneck in the operation.

In view of the above, the object of this invention is to provide a storage apparatus that can operate in RAID modes other than RAID 3 or RAID 4 and can change from one RAID mode to another while maintaining the contents stored in the pre-existing storage media, and also to provide a control method for the storage apparatus.

In order to solve the problem mentioned above, this invention has the following features.

According to one of the features of this invention, there is provided a storage apparatus (e.g. RAID-functioning NAS 100) comprising: a storage unit (e.g. disk array 170) including plural storage media (e.g. HDDs); and a controller (e.g. processor 110) for controlling the storage unit. After a new storage medium has been added to the storage unit, the controller causes the new storage medium to store error correction codes for data stored in the respective storage media pre-existing in the storage unit. When new data is stored in the storage unit after the addition of the new storage medium, the controller causes the pre-existing storage media and the new storage medium to dispersedly store the new data and the error correction codes for the new data.

According to such a feature, the controller causes the new storage medium to store the error correction codes for the data stored in the storage media pre-existing in the storage unit, after the new storage medium has been added to the storage unit. Thus, the data stored in the new storage medium is the error correction codes for the data stored in the pre-existing storage media, whereby the contents stored in the storage media can be maintained. Accordingly, any of various RAID modes such as RAID 1 or RAID 5 can be used before the addition of the new storage medium to the storage unit.

Furthermore, for storing new data in the storage unit after the addition of the new storage medium, the controller causes the storage media and the new storage medium to dispersedly store the new data and the error correction codes for the new data. Thus, after the addition of the new storage medium, the apparatus can operate in the mode of RAID 5 or RAID 6. The bottleneck in RAID 3 or RAID 4 may not occur in RAID 5 or RAID 6, whereby write performance in RAID 5 or RAID 6 can be improved in comparison with RAID 3 or RAID 4.

According to the above-mentioned feature, it is possible to provide a storage apparatus that can operate in RAID modes other than RAID 3 or RAID 4 and can change from one RAID mode to another while maintaining the contents stored in the pre-existing storage media.

According to another feature of a storage apparatus of this invention, before the addition of the new storage medium, the controller causes the pre-existing storage media to dispersedly store data and their error correction codes.

According to another feature of a storage apparatus of this invention, after the addition of the new storage medium, the controller causes the pre-existing storage media and the new storage medium to dispersedly store data and their error correction codes which are greater in the number of types than before the addition of the new storage medium to the storage unit.

According to another feature of a storage apparatus of this invention, before the addition of the new storage medium, the controller causes the pre-existing storage media to store the same data.

According to another feature of a storage apparatus of this invention, after the addition of the new storage medium, the controller causes the pre-existing storage media and the new storage medium to dispersedly store data and their error correction codes.

According to another feature of a storage apparatus of this invention, the controller causes the new storage medium to store the error correction codes for the data stored in the pre-existing storage media, when a predetermined operation is instructed from a user after the new storage medium has been added to the storage unit.

According to one of the features of this invention, there is provided a control method for a storage apparatus including a storage unit having plural storage media, comprising: the step of storing, after the addition of a new storage medium to the storage unit, in the new storage medium, the error correction codes for the data stored in the respective storage media pre-existing in the storage unit; and the step of dispersedly storing new data and the error correction codes for the new data in the pre-existing storage media and the new storage medium, when the new data is stored in the storage unit after the addition of the new storage medium.

### BRIEF DESCRIPTION OF THE DRAWINGS

FIG. 1 is an overall view of a communication system including a RAID-functioning NAS according to a first embodiment and a second embodiment of this invention.

FIG. 2 shows in block diagram the configuration of hardware of the RAID-functioning NAS according to the first embodiment of this invention.

FIG. 3 shows the configuration of software of the RAID-functioning NAS according to the first embodiment of this invention.

FIG. 4 illustrates an operation for adding a new HDD according to the first embodiment of this invention.

FIG. 5 illustrates an operation of data writing after the addition of the new HDD according to the first embodiment of this invention.

FIG. 6 shows in block diagram the configuration of hardware of a RAID-functioning NAS according to a second embodiment of this invention.

FIG. 7 illustrates an operation for adding a new HDD according to the second embodiment of this invention.

FIG. 8 illustrates an operation for data writing after the addition of the new HDD according to the second embodiment of this invention.

### DESCRIPTION OF THE EMBODIMENTS

A RAID-functioning NAS (network attached storage) as an embodiment of a storage apparatus according to this invention is described with reference to the attached drawings. In the drawings, the same or similar components are labeled with the same or similar reference numerals.

In the RAID-functioning NAS according to the embodiments below, a disk array as a storage unit is formed of plural hard disk drives (HDDs) as storage media. The storage medium is not limited to the HDD, but an optical drive or a solid state drive (SSD) including a non-volatile semiconductor memory may be used.

### (1) First Embodiment

In the first embodiment, (1.1) Overall Configuration, (1.2) Detailed Configuration of RAID-Functioning NAS, (1.3) RAID Mode Change from RAID 5 to RAID 6, and (1.4) Obtained Results, are described in this order.

### (1.1) Overall Configuration

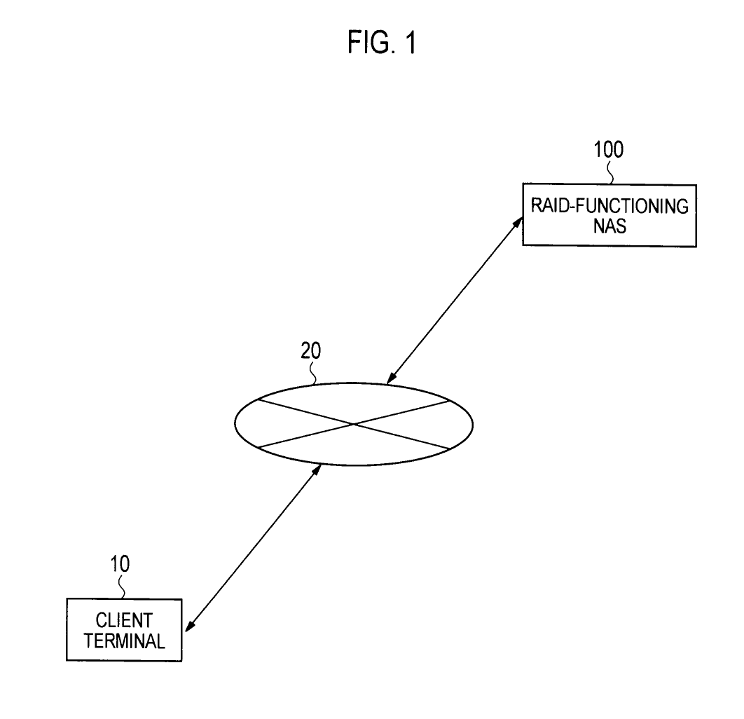

FIG. 1 shows in block diagram a communication system including a RAID-functioning NAS 100 according to this embodiment.

As shown in FIG. 1, the RAID-functioning NAS 100 is connected to a network 20 such as a local area network (LAN).

A client terminal 10 is a personal computer (PC), a network-connectable television set, or the like. The client terminal 10 is connected to the network 20 and performs data communications with the RAID-functioning NAS 100 through the network 20.

The RAID-functioning NAS 100 stores the data received from the client terminal 10 through the network 20.

The RAID-functioning NAS 100 according to the first embodiment functions as RAID 5 and RAID 6. In RAID 5, error correction codes of a type (i.e. a first type) and data are dispersedly stored in plural HDDs. In RAID 6, error correction codes of two types (i.e. first and second types) and data are dispersedly stored in plural HDDs.

### (1.2) Detailed Configuration of RAID-Functioning NAS

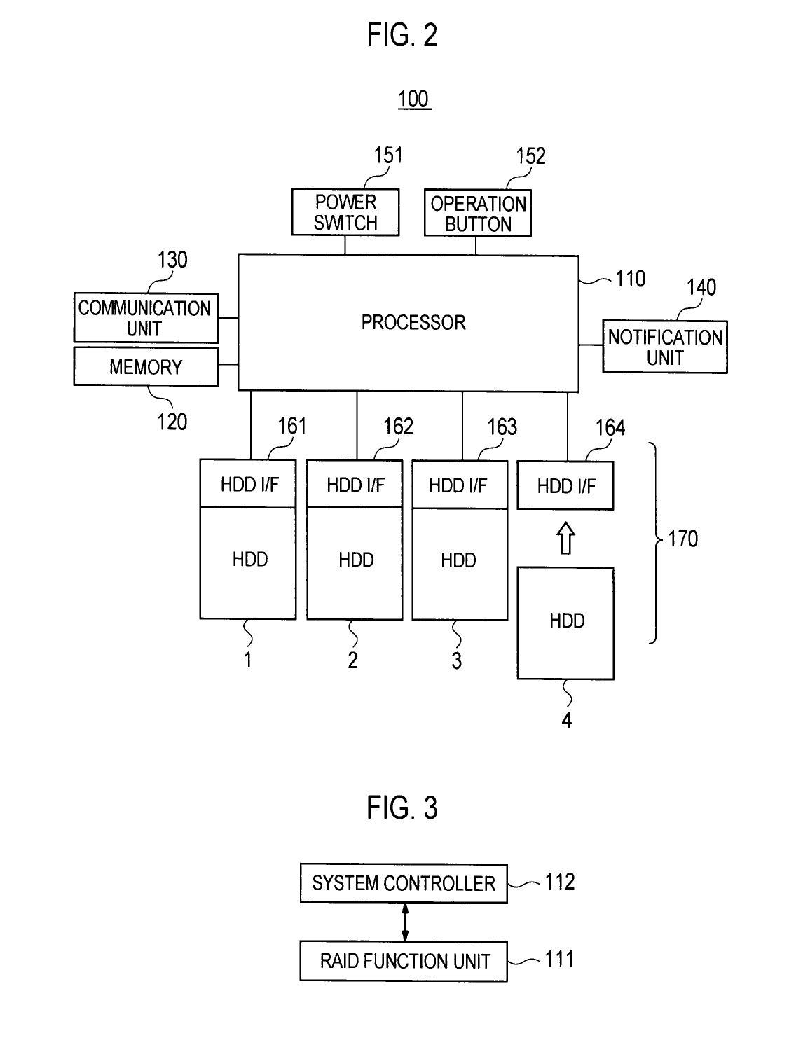

A detailed configuration of the RAID-functioning NAS 100 is described below with reference to FIG. 2 and FIG. 3.

### (1.2.1) Hardware Configuration

FIG. 2 shows the hardware configuration of the RAID-functioning NAS 100 according to the first embodiment. Four HDDs at most can be detachably attached to the RAID-functioning NAS 100 according to the first embodiment.

As shown in FIG. 2, the RAID-functioning NAS 100 according to the first embodiment includes a processor 110, a memory 120, a communication unit 130, a notification unit 140, a power switch 151, an operation button 152, an HDD I/F 161, an HDD I/F 162, an HDD I/F 163, and an HDD I/F 164.

The processor 110, serving as a controller, controls the RAID-functioning NAS 100 as a whole and is electrically connected to the memory 120, the communication unit 130, the notification unit 140, the power switch 151, the operation button 152, and the HDD I/Fs 161 to 164.

The memory 120 is a non-volatile semiconductor memory for example. The memory 120 stores therein a control program to be executed by the processor 110 and is also used as a work area for the processor 110.

The communication unit 130 is connected to the network 20. The communication unit 130, under the control by the processor 110, transmits the data read from the HDD and receives the data to be written in the HDD through the network 20. The communication unit 130, under the control by the processor 110, receives information (command) representing the user operation from the client terminal 10 through the network 20.

The notification unit 140 is a liquid crystal display or a light emitting diode (LED) for example. The notification unit 140, under the control by the processor 110, issues various notifications to the user.

The power switch 151 is operated by the user to turn off or on the RAID-functioning NAS 100. The operation button 152 is used to instruct the start of the change in RAID mode described below.

Each of the HDD I/Fs 161 to 164 is a serial ATA (SATA) interface for example. HDDs 1 to 4 can be connected to the HDD I/Fs 161 to 164, respectively.

In FIG. 2, a disk array 170 is shown as having the HDDs 1 to 3 connected respectively to the HDD I/Fs 161 to 163, and the disk array 170 is composed of the HDDs 1 to 3.

In the first embodiment, under the control of the processor 110, the disk array 170 including the HDDs 1 to 3 operates as RAID 5 until the HDD 4 is connected to the HDD I/F 164.

Then, when the HDD 4 is connected to the HDD I/F 164, the processor 110 performs control so that the disk array 170 now including the HDDs 1 to 4 can operate as RAID 6.

### (1.2.2) Software Configuration

FIG. 3 shows the software configuration of the RAID-functioning NAS according to the first embodiment of this invention.

As shown in FIG. 3, the processor 110 executes the functions of a RAID function unit 111 and a system controller 112. The RAID function unit 111 performs control such as the error correction code calculation and lost data recovery, in accordance with the ongoing RAID mode. The system controller 112 performs the control related to the entire RAID-functioning NAS, such as change in RAID mode. Thus, the RAID-functioning NAS 100 realizes the RAID function through the execution of the software RAID.

In the first embodiment, the processor 110 controls the change in the RAID mode from RAID 5 to RAID 6. The change in the RAID mode from RAID 5 to RAID 6 is described below.

(1.3) RAID Mode Change from RAID 5 to RAID 6

The RAID mode change from RAID 5 to RAID 6 is described in the order of (1.3.1) Operation for Adding New HDD and (1.3.2) Operation for Data Writing after Addition of New HDD.

### (1.3.1) Operation for Adding New HDD

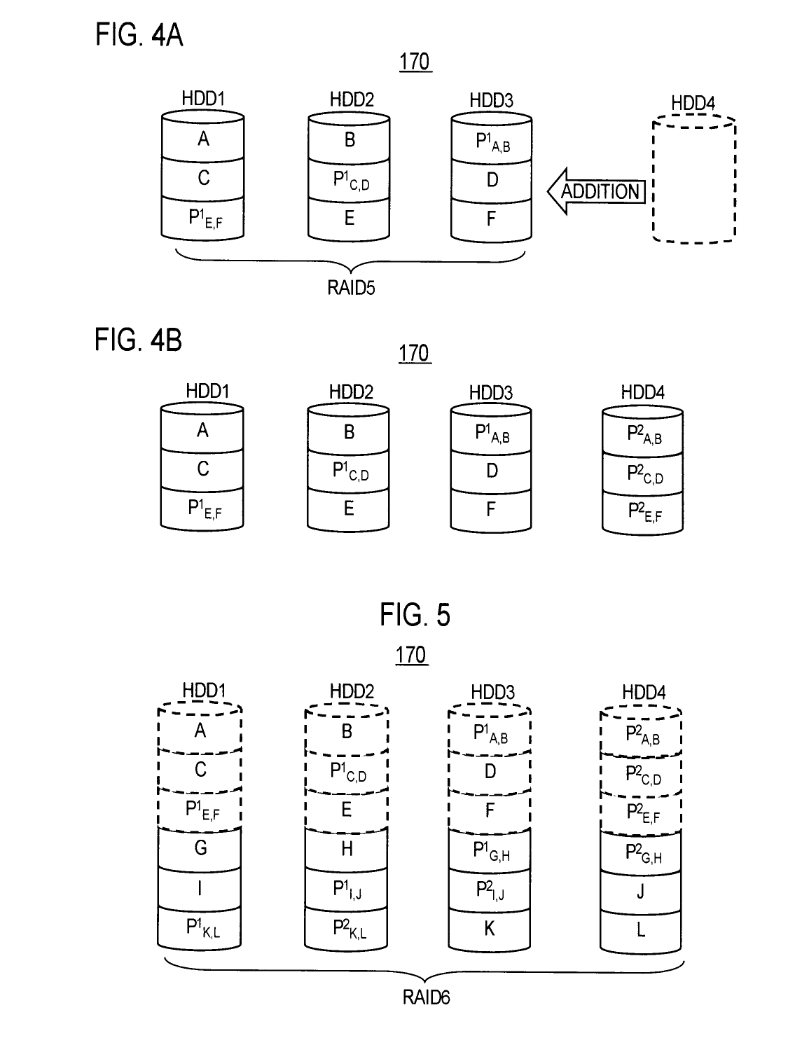

FIG. 4 illustrates the operation for adding a new HDD 4 to the disk array 170.

As shown in FIG. 4A, the processor 110 writes data in the disk array 170 in accordance with RAID 5 mode before the new HDD 4 is added to the disk array 170. Thus, the processor 110 causes the HDDs 1 to 3 to dispersedly store the data and error correction codes of the first type for the data.

In the example shown in FIG. 4A, the processor 110 causes data A to be stored in the HDD 1, data B in the HDD 2, and error correction code P¹_{A, B} for the data A and B in the HDD 3.

In addition, the processor 110 causes data C to be stored in the HDD 1, data D in the HDD 3, and error correction code P¹_{C, D} for the data C and D in the HDD 2.

Moreover, the processor 110 causes data E to be stored in the HDD 2, data F in the HDD 3, and error correction code P¹_{E, F} for the data E and the data F in the HDD 1.

For example, the error correction code P¹_{A, B} is generated by making the XOR of the data A and B, the error correction code P¹_{C, D} is generated by making the XOR of the data C and D, and the error correction code P¹_{E, F} is generated by making the XOR of the data E and t F.

When new HDD 4 is connected to the HDD I/F 164, the processor 110 senses that the new HDD 4 is connected to the HDD I/F 164. Then the processor 110 controls the notification unit 140 so that the notification that the RAID mode can be changed from RAID 5 to RAID 6 can be given. The reception of the user operation instructing the RAID mode change to RAID 6 by the operation button 152 thereafter is sensed by the processor 110.

After sensing the connection of the HDD 4 and the operation instructing the RAID mode change to RAID 6, the processor 110 generates the error correction codes for the data stored in the pre-existing HDDs 1 to 3 and causes the generated error correction codes to be stored in the new HDD 4 as shown in FIG. 4B.

The generated error correction codes are different in type from the error correction codes stored in the pre-existing HDDs 1 to 3 (i.e. error correction codes obtained through different calculation).

In the example shown in FIG. 4B, the processor 110 causes error correction code P²_{A, B} for the data A and B to be stored in the HDD 4, error correction code P²_{C, D} for the data C and D in the HDD 4, and error correction code P²_{E, F} for the data E and F in the HDD 4.

For example, the error correction code P²_{A, B} is a Reed Solomon code for the data A and B, the error correction code P²_{C, D} is a Reed Solomon code for the data C and D, and the error correction code P²_{E, F} is a Reed Solomon code for the data E and F.

Thus, the RAID mode change from RAID 5 to RAID 6 is initiated. Note that the HDD 4 serves as an error-correction-dedicated storage media at this point in time.

(1.3.2) Operation for Data Writing after Addition of New HDD

FIG. 5 illustrates the operation for data writing after the addition of a new HDD.

As shown in FIG. 5, when new data is stored in the disk array 170 after the addition of the new HDD 4, the processor 110 generates two types of error correction codes (i.e. error correction codes of the first and second types) for the new data and causes the pre-existing HDDs 1 to 3 and the new HDD 4 to store the new data and the error correction codes of both types in a dispersed manner.

In the example shown in FIG. 5, the processor 110 causes data G to be stored in the HDD 1, data H in the HDD 2, error correction code P¹_{G, H} for the data G and a H in HDD 3, and error correction code P²_{G, H} for the data G and H in HDD 4. For example, the error correction code P¹_{G, H} is generated by making the XOR of the data G and H, and the error correction code P²_{G, H} is a Reed Solomon code generated for the data G and H.

In addition, the processor 110 causes data I to be stored in the HDD 1, data J in the HDD 4, error correction code P¹_{I, J} for the data I and J in HDD 2, and error correction code P²_{I, J} for the data I and J in HDD 3. For example, the error correction code P¹_{I, J} is generated by making the XOR of the data I and J, and the error correction code P²_{I, J} is a Reed Solomon code generated for the data I and J.

Moreover, the processor 110 causes data K to be stored in the HDD 3, data L in the HDD 4, error correction code P¹_{K, L} for the data K and L in HDD 1, and error correction code P²_{K, L} for the data K and L in HDD 2. For example, the error correction code P¹_{K, L} is generated by making the XOR of the data K and L, and the error correction code P²_{K, L} is a Reed Solomon code generated for the data I and J.

Thus, the HDD 4 stores not only the error correction codes but also the data. As a result, the HDD 4 does not need to be accessed for every data update.

### (1.4) Obtained Result

As described above, in the first embodiment, when the new HDD 4 is added to the disk array 170, the RAID-functioning NAS 100 stores in the new HDD 4 the error correction codes for the data stored in the HDDs 1 to 3 forming the disk array 170 operated in the RAID 5 mode. Thus, the initial data stored in the new HDD 4 is the error correction codes for the data stored in the pre-existing HDDs 1 to 3, whereby the data and the error correction code stored in the pre-existing HDDs 1 to 3 can be maintained.

When new data is stored in the disk array 170 after the addition of the new HDD 4, the processor 110 causes the pre-existing HDDs 1 to 3 and the new HDD 4 to dispersedly store the new data and the error correction codes for the new data. Thus, the disk array 170 can be operated in the RAID 6 mode after the new HDD 4 has been added.

As a result, the RAID mode change from RAID 5 to RAID 6 can be achieved while the data and the error correction codes stored in the pre-existing HDDs 1 to 3 are maintained. Moreover, since the data and the error correction codes stored in the pre-existing HDDs 1 to 3 are maintained, the disk array 170 can be accessed during the RAID mode change, whereby downtime in the system can be minimized.

In the first embodiment, the processor 110 initiates the RAID mode change to RAID 6 after the new HDD 4 has been added to the disk array 170 and the user operation instructing the RAID mode change to RAID 6 has been received. Thus, even when the new HDD 4 is added to the disk array 170, the RAID mode change to RAID 6 is conducted only after the change instruction from the user has been received, whereby RAID mode change from RAID 5 to RAID 6 unintended by the user can be prevented.

### (2) Second Embodiment

RAID mode change from RAID 1 to RAID 5 is described in a second embodiment.

Description of the second embodiment is given below in the order of (2.1) Detailed Configuration of RAID-Functioning NAS, (2.2) RAID Mode Change from RAID 1 to RAID 5, and (2.3) Obtained Result. The description is mainly given on what is different from the first embodiment and no overlapping explanation will be given.

### (2.1) Detailed Configuration of RAID-Functioning NAS

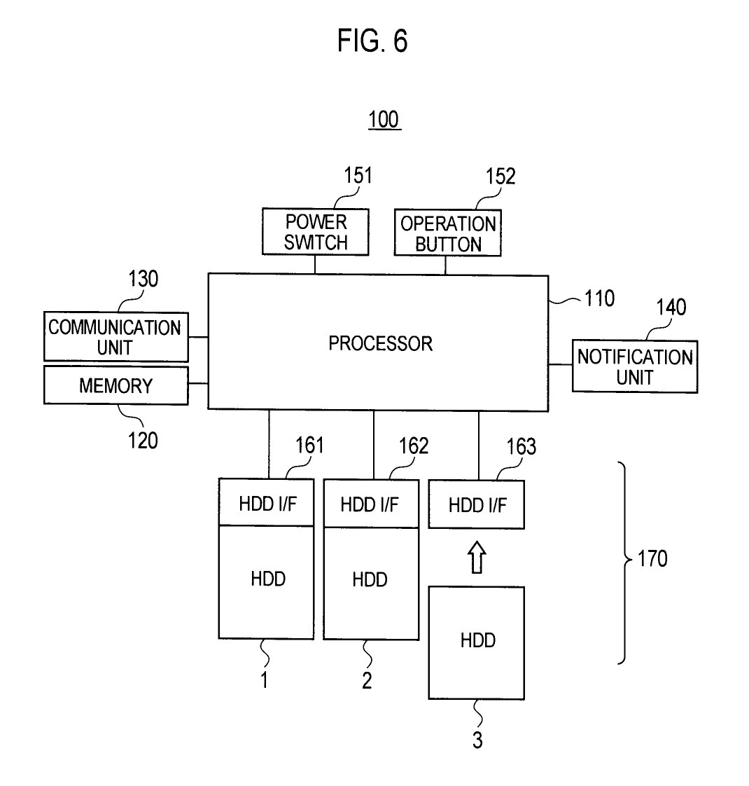

FIG. 6 shows a configuration of hardware of the RAID-functioning NAS 100 according to the second embodiment.

As shown in FIG. 6, the RAID-functioning NAS 100 according to the second embodiment to which at most three HDDs can be attached, includes HDD I/Fs 161 to 163. The RAID-functioning NAS 100 may be configured to include four or more HDDs attached thereto.

The RAID-functioning NAS 100 according to the second embodiment can work as at least RAID 1 or RAID 5. In RAID 1, the same data is stored in plural HDDs. In RAID 5, error correction codes of a type and the data are dispersedly stored in plural HDDs.

In FIG. 6, the disk array 170 includes the HDDs 1, 2 connected respectively to the HDD I/Fs 161, 162. In the second embodiment, under the control of the processor 110, the disk array 170 including the HDDs 1, 2 is operated in the RAID 1 mode until the HDD 3 has been connected to the HDD I/F 163.

Then, when the HDD 3 is connected to the HDD I/F 163, the processor 110 performs control so that the disk array 170 including the HDDs 1 to 3 can be operated in the RAID 6 mode. The RAID mode change from RAID 1 to RAID 5 is described below.

(2.2) RAID Mode Change from RAID 1 to RAID 5

The RAID mode change from RAID 1 to RAID 5 is described in the order of (2.2.1) Operation for Adding New HDD and (2.2.2) Operation for Data Writing after Addition of New HDD.

### (2.2.1) Operation for Adding New HDD

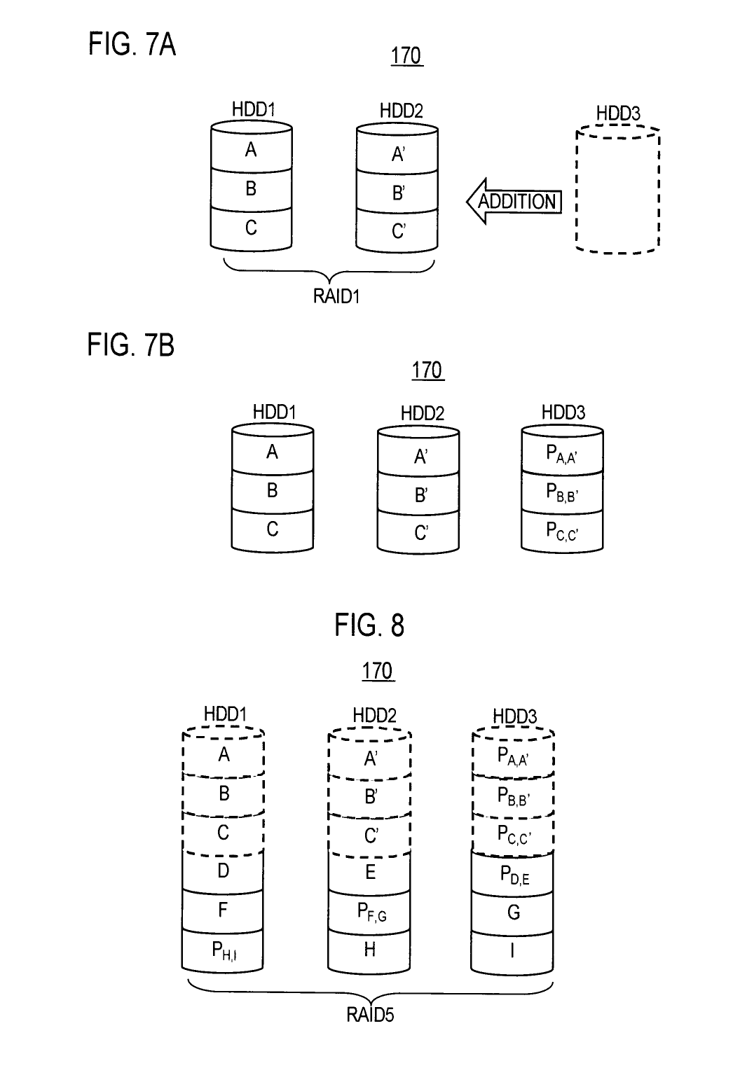

FIG. 7 illustrates an operation for adding a new HDD.

As shown in FIG. 7A, the processor 110 writes data in accordance with RAID 1 before the new HDD 3 is added to the disk array 170. Thus, the processor 110 causes the pre-existing HDDs 1, 2 to dispersedly store the same data.

In the example shown in FIG. 7A, the processor 110 causes data A to be stored in the HDD 1, data A′ in the HDD 2, data B in the HDD 1, data B′ in the HDD 2, data C in the HDD 1, and data C′ in the HDD 2.

When new HDD 3 is connected to the HDD I/F 163, the processor 110 senses that the new HDD 4 is connected to the HDD I/F 164. Then the processor 110 controls the notification unit 140 so that the notification indicating that the RAID mode can be changed to RAID 5 can be given. The reception of the user operation instructing the RAID mode change to RAID 5 by the operation button 152 thereafter is sensed by the processor 110.

After sensing the connection of the HDD 3 and the operation instructing the RAID mode change to RAID 5, the processor 110 generates the error correction codes for the data stored in the pre-existing HDDs 1, 2 and causes the new HDD 3 to store the generated error correction codes as shown in FIG. 7B.

In the example shown in FIG. 7B, the processor 110 causes error correction code P_{A, A′} for the data A and A′ to be stored in the HDD 3, error correction code P_{B, B′} for the data B and B′ in the HDD 3, and error correction code P_{C, C′} for the data C and C′ in the HDD 3.

For example, the error correction code P_{A, A′} is generated by making the XOR of the data A and A′, the error correction code P_{B, B′} is generated by making the XOR of the data B and B′, and the error correction code P_{C, C′} is generated by making the XOR of the data C and C′.

Thus, the RAID mode change from RAID 1 to RAID 5 is initiated. Note that the HDD 3 serves as an error-correction-dedicated storage media at this point in time.

(2.2.2) Operation for Data Writing after Addition of New HDD

FIG. 8 is illustrates an operation for data writing after the addition of the new HDD.

As shown in FIG. 8, for newly storing data in the disk array 170 after the addition of the new HDD 3, the processor 110 generates error correction codes of the first type for the new data and causes the pre-existing HDDs 1, 2 and the new HDD 3 to store the new data and the error correction codes of a type in a dispersed manner.

In the example shown in FIG. 8, the processor 110 causes data D to be stored in the HDD 1, data E in the HDD 2, and error correction code P_{D, E} for the data D and E in HDD 3. For example, the error correction code P_{D, E} is generated by making the XOR of the data D and E.

In addition, the processor 110 causes data F to be stored in the HDD 1, data G in the HDD 3, and error correction code P_{F, G} for the data F and G in HDD 2. For example, the error correction code P_{F, G} is generated by making the XOR of the data F and G.

Moreover, the processor 110 causes data H to be stored in the HDD 2, data I in the HDD 3, error correction code P_{H, I} for the data H and I in HDD 1. For example, the error correction code P_{H, I} is generated by making the XOR of the data H and I. Thus, the HDD 3 stores not only the error correction codes but also the data. As a result, the HDD 3 does not need to be accessed for every data update.

### (2.3) Obtained Result

As described above, in the second embodiment, after the new HDD 3 has been added to the disk array 170, the RAID-functioning NAS 100 causes the error correction codes for the data stored in the pre-existing HDDs 1, 2 forming the disk array 170 operated in the RAID 1, to be stored in the newly added HDD 3. Thus, initial data to be stored in the new HDD 3 added to the disk array 170 is the error correction codes for the data stored in the pre-existing HDDs 1, 2, whereby the data stored in the pre-existing HDDs 1, 2 can be maintained.

After the new data has been stored in the disk array 170 following the addition of the new HDD 3, the processor 110 causes the pre-existing HDDs 1, 2 and the new HDD 3 to dispersedly store the new data and the error correction codes of a type for the new data. Thus, the disk array 170 can be operated in the RAID 5 mode after the new HDD 3 has been added.

As a result, RAID mode change from RAID 1 to RAID 5 can be achieved while the data stored in the pre-existing HDDs 1, 2 are maintained. Moreover, since the data and the error correction codes stored in the pre-existing HDDs 1, 2 are maintained, the disk array 170 can be accessed during the RAID mode change, whereby downtime in the system can be minimized.

In the second embodiment, the processor 110 initiates the RAID mode change to RAID 5 after the new HDD 3 has been added to the disk array 170 and the user operation instructing the RAID mode change to RAID 5 has been received. Thus, even when the new HDD 3 is added to the disk array 170, the RAID mode change to RAID 5 is conducted only after the change instruction from the user has been received, whereby RAID mode change from RAID 1 to RAID 5 unintended by the user can be prevented.

### (3) Other Embodiments

As described above, the details of the present invention have been disclosed by using the embodiments of the present invention. However, it should not be understood that the description and drawings which constitute part of this disclosure limit the present invention. From this disclosure, various alternative embodiments, examples, and operation techniques will be easily thought of by those skilled in the art.

RAID mode change from RAID 5 to RAID 6 is described in the first embodiment. RAID mode change from RAID 1 to RAID 5 is described in the second embodiment. Still, the technical idea of this invention may also be applied to changes among other RAID modes without being limited to those from RAID 5 to RAID 6 and from RAID 1 to RAID 5.

An example where RAID is formed with software RAID is described in the above embodiments. Instead, RAID may be formed with hardware RAID using an IC dedicated for RAID. In such a case, the controller is made up of the IC dedicated for RAID and the processor.

In the above described embodiments, the notification unit 140 is a liquid crystal display or an LED. Notification may also be given through sounds. Notification may also be given on the client terminal 10 through the network 20. In such a case, the communication unit 130 serves as a part of the notification unit 140. The operation button 152, which is a mechanical push button in the embodiments, may also be a touch panel and the like as long as it can receive the user operation.

In the above embodiments, the RAID-functioning NAS 100 is described as an embodiment of the storage apparatus according to this invention. Still, instead of the RAID-functioning NAS 100, this invention may also be applied to other storage apparatuses such as a universal serial bus (USB) connected storage apparatus, a large file server, or a PC server.

In this manner, this invention naturally includes various modes of practice not specifically described herein.

What is claimed is:

1. A storage apparatus comprising:
a storage unit including plural storage media; and
a controller for controlling the storage unit,
wherein after a new storage medium has been added to the storage unit, the controller causes the new storage medium to store error correction codes for data stored in the respective storage media pre-existing in the storage unit, and
when new data is stored in the storage unit after the addition of the new storage medium, the controller causes the pre-existing storage media and the new storage medium to dispersedly store the new data and error correction codes for the new data.

2. The storage apparatus according to claim 1, wherein before the addition of the new storage medium, the controller causes the pre-existing storage media to dispersedly store data and error correction codes for the data.

3. The storage apparatus according to claim 2, wherein after the addition of the new storage medium, the controller causes the pre-existing storage media and the new storage medium to dispersedly store data and error correction codes which are greater in the number of types than before the addition of the new storage medium to the storage unit.

4. The storage apparatus according to claim 1, wherein before the addition of the new storage medium, the controller causes the pre-existing storage media to store the same data.

5. The storage apparatus according to claim 4, wherein after the addition of the new storage medium, the controller causes the pre-existing storage media and the new storage medium to dispersedly store data and error correction codes.

6. The storage apparatus according to claim 1, wherein the controller causes the new storage medium to store error correction codes for data stored in the pre-existing storage media, when an instruction for a predetermined operation is received from a user after the new storage medium has been added to the storage unit.

7. A control method for a storage apparatus including a storage unit having plural storage media, comprising:
the step of storing, in the new storage medium, error correction codes for data stored in the respective storage media pre-existing in the storage unit, after the addition of a new storage medium to the storage unit; and
the step of dispersedly storing new data and error correction codes for the new data in the pre-existing storage media and the new storage medium, when the new data is stored in the storage unit after the addition of the new storage medium.
